(19) United States
(12) Patent Application Publication
(10) Pub. No.: US 2013/0175372 A1
(43) Pub. Date: Jul. 11, 2013

(54) METHODS AND APPARATUS FOR TRIMMING PLANTS

(71) Applicant: MOSMAN MACHINERY COMPANY, INC., Nevada City, CA (US)

(72) Inventor: Don Mosman, Nevada City, CA (US)

(73) Assignee: MOSMAN MACHINERY COMPANY, INC., Nevada City, CA (US)

(21) Appl. No.: 13/781,007

(22) Filed: Feb. 28, 2013

Related U.S. Application Data
(63) Continuation-in-part of application No. 13/067,073, filed on May 4, 2011.

(51) Int. Cl. B02C 18/16; B02C 23/00; B02C 19/00

(52) U.S. Cl. CPC B02C 18/16; B02C 19/0056; B02C 23/00
USPC 241/25; 241/227; 241/230; 241/167; 241/28

(57) ABSTRACT

The present invention discloses an apparatus for trimming plants, in particular, buds and flowers, to remove unwanted plant material. A typical application would be to process a plant to leave only trimmed buds and flowers for use in potpourri, fragrant sashes, or as a prelude to further processing of essential oils. The invention enables faster and safer production of plant material than prior plant processing machines. The apparatus employs an original combination of a slotted metal drum and a lawn mower type cutting reel that are rotated in the same direction, but at different speeds, to create a cutting interface that shears the unwanted plant material off and then collect this debris though a novel vacuum manifold into a waste collection device. The cutting interface between the slotted drum and the cutting reel is adjustable to keep the distance between the two between 0.002 and 0.006 inches for a very sharp and clean cut. The invention includes a roller brush and sprayer system to keep the cutting interface clean, without buildup of oils and other organic plant material. The invention is built upon a frame that moves on wheels and that allows for adjustment for operation in a level or tilted configuration to best suit the processing of particular types of plant material. The manifold cover is easily removed for cleaning and for sharpening or adjustment of the cutting blades.

### PRIORITY

This application is a continuation-in-part of U.S. application Ser. No. 13/067,073, filed May 4, 2011 and entitled Method and Apparatus for Trimming Buds and Flowers, which is incorporated by reference in its entirety.

### FIELD OF THE INVENTION

The present invention relates to the trimming of plants. In particular, but not by way of limitation the present invention relates to the trimming of plant buds and flowers.

### BACKGROUND OF THE INVENTION

Prior art machines and methods are known for cutting, chipping, trimming, and grinding plant materials for a variety of purposes such as for gardening, making wood products, food processing, agriculture, and composting. Although there are a number of prior art apparatuses in these related fields, there are only a couple of apparatuses that are sufficiently related in purpose and/or design to that of the present invention that bear detailed discussion.

One such prior art apparatus as described in U.S. Pat. No. 7,168,643 (Mercier) describes a leaf snatcher for taking leaves and other small plant debris and putting this material into a waste container. This apparatus, which is specifically designed for yard cleanup of leaves and small plant debris, uses a round, horizontal grate with a rotating cutting blade underneath designed to create a vacuum to pull the plant material through the grate into a waste receptacle. This machine is designed for coarse cutting and suction of the material and not for careful trimming of the plant material and therefore is not appropriately designed for effective use with the preparation of potpourri, catnip, and other decorative, olfactory, and other types of products.

Another prior art apparatus is published U.S. Patent Application No. 2007/0069056A1 (Shouse, et al). This application describes an apparatus and method for trimming plants to make such things as potpourri and other displays. The apparatus, which was intended for trimming flowers, uses a simple round, horizontal grating located just above a rotating blade to trim off unwanted parts of a flower/plant that extend through the grating and are sheared by the horizontally rotating blade. The machine generates a greater volume of flower petals as compared to the traditional method of hand trimming with a scissors. However, as pointed out in its specification, the flowers or other plant parts must still be “rolled on the machine” (i.e., around the top side of the grating) by hand. The specification admits that the machine only “reduces” the amount of labor formerly needed to perform this task.

Another example is set out in U.S. Pat. No. 7,028,844 (Nelson) which describes a machine for processing dried lavender. This apparatus utilizes two horizontally oriented opposing belt rollers to form a moving conveyor that moves the lavender. The process of crushing the lavender between the belts results in the flower buds substantially separating from the stems and falling to a collection bin below the belts. The use of this apparatus has a number of drawbacks: it still requires significant hand labor to insert the lavender into the apparatus in a manner that avoids jamming or overflowing. Moreover, damage to the flower buds occurs, resulting in the creation of significant amounts of chaff and debris that must be further separated and portions collected as dust that must be discarded.

As shown above with the state of the prior art, there is still considerable hand and manual labor required for trimming plant buds and flowers. Furthermore, the finished quality of the desired plant portions such as, but not limited to, flower buds, is not easily controllable and desired portions of the plants are often crushed and/or cut away using the above-reference prior art. For certain types of finished products, this is a serious drawback and is the reason that most plant processing of this type is still done with hand cutting. Additional drawbacks include that the above described inventions can only operate with dry plant material and therefore become clogged or gummed up when the particular type of plant being processed has greater amounts of natural surface oils and resins on its stems, leaves, and flowers. The aforementioned inventions further pose a hazard for the operator or the operator's clothing because the inventions create a possibility that hair, a piece of clothing or a small appendage, or another item could get caught in the apparatus during use. All of the above negative factors add to the cost of production and to non-optimal product quality and safety issues for the operator.

### SUMMARY OF THE INVENTION

In order to create an apparatus that is less labor intensive, has superior controllability of the end-product quality, can operate with plants with varying degrees of oils, and has significantly improved safety for the operator, an invention as described herein was created. One embodiment of the invention comprises a cutting interface comprising a slotted drum and cutting reel which are located parallel to each other and in very close proximity (typically 0.002″ to 0.006″). The slotted drum is mounted with precision bearings on both of its ends and is rotated by means of an electric motor and timing belt. The cutting reel is likewise mounted with precision bearings on both of its ends and is rotated in the same direction as the slotted drum but at a much higher speed. The cutting reel comprises multiple curved blades (typically in a “lawn mower” type configuration of eight blades, with each blade having 90 degrees of rotation from one end of the cutting reel to the other), so that the cutting interface can act in the manner of a shear when a point on one of the blades of the rotating cutting reel comes closest to a point on the edge of a slot in the differentially rotating slotted drum (i.e., at a tangent point), and so that a cutting point on an individual blade on the cutting reel moves from one end of the slotted drum to the other end in a straight line, which is hereafter referred to as the tangent cutting line. The tangent cutting line typically is located approximately 12 degrees offset from the physical bottom of the slotted drum.

According to another aspect of the invention, there is provided a cleaning system for the slotted drum comprising a roller cleaning brush that runs parallel to the slotted drum and touches it lengthwise so as to wipe off physical debris and fluids from the plant material left over from the shearing done along the cutting interface. The roller brush is adjustable as to the amount of pressure applied against the slotted drum. The slotted drum cleaning system further comprises a series of sprayers mounted on a tube which is positioned overhead and parallel to the slotted drum, with the sprayers being pointed towards the slotted drum and spaced so as to provide a full spray coverage of the slotted drum as it rotates. The sprayer system typically employs water as the cleaning fluid.

According to another aspect of the invention, there is provided a vacuum manifold for extracting the plant material that is cut off by the apparatus as waste. The vacuum manifold system is fitted around the cutting reel, except for a small part of the cutting reel circumference which forms a linear aperture where the cutting interface resides. The vacuum manifold is hinged across its length and held in place by spring loaded pins to facilitate easy removal for cleaning and/or sharpening of the cutting reel blades.

According to another aspect of the invention, there is provided a metal frame with front and back end plates for holding the cutting interface and the cleaning system in a horizontal position. The metal frame is constructed to have the ability to be level or lower on the side of the cutting interface that outputs plant material such that, when that side is lowered, gravity assists the flow of the plant material through the slotted drum so that the operator will have minimal work to keep the flow of plant material going through the apparatus.

According to another aspect of the invention, there is provided a pair of adjustable bearing mounts for the cutting reel, with one adjustable bearing mount being mounted on the front frame plate and the second adjustable bearing mount being mounted on the rear frame plate with the adjustable bearing mounts holding the cutting real at each end. The adjustable bearing mounts are made with a small offset from their centers so that placement of the bearings for holding the cutting reel can adjust the distance of ends of the cutting reel blades from the surface of the slotted drum. The adjustable bearing mounts are held in place by means of a rotatable clamp on the opposite side of both the front and rear frame end plates and are capable of being un-clamped, rotated, and then re-clamped for the purpose of causing the slightly offset bearing to be closer to, or further from, the centerline of the slotted drum, thereby allowing for the adjustment of the cutting interface (i.e., the distance) between the slotted drum and the cutting reel (typically varying from 0.002″ to 0.006″).

Embodiments of the invention provide a slotted drum into which the plant material is loaded on one end and from which the processed plant material exits from the other end as a result of the combination of the rotating motion of the slotted drum, the movement of the shearing (tangent) point along the tangent cutting line that runs from one end of the slotted drum to the other end of the slotted drum, and/or the effect of gravity created when the metal frame is lowered to a less than horizontal position on the output end. The slotted drum is configured from by a single metal tube that contains horizontal rows of slots around its periphery. The slotted drum is rotated by means of an electric motor that drives a timing belt that is fitted about a timing belt pulley mounted on one end of the slotted drum. The typical embodiment of the slotted drum comprises a 0.120″ thick wall machined steel tube with horizontal rows of approximately 0.312″ wide slots that are approximately 4″ in length, with seven slots per horizontal row. However, the slotted drum can be implemented with other metals, different thicknesses, row spacing, slot lengths and widths, and means of being rotated (such as a roller or V-belt drive) as an embodiment of the invention.

Compared to existing open, horizontal, flat grate designs or the dual converging belt design, the slotted drum embodiment provides a much more gentle and effective means for having only the undesired portions of the plant (such as outer portions of leaves, stems, thorns, etc.) put into the cutting interface, thereby reducing waste and creating a higher quality of finish trimming to the flower, bud or other portion of the plant which is desired as an end product. The slotted drum also provides a safer method for processing the plant material because the human operator only has to place the plant material into the input end of the slotted drum, thereby keeping the operator's hands and clothing away from the cutting interface.

Embodiments of the invention provide a cutting reel that is mounted with bearings having an adjustable position on both its ends such that the cutting real is adjusted to be parallel to the slotted drum with only a small gap of typically 0.002 to 0.006 inches. The cutting reel is rotated by means of an electric motor that drives a timing belt that is fitted about a timing belt pulley or mounted on one end of the cutting reel. A timing belt is a preferred means because such a coupling militates against slippage. However, there is typically no timing function implemented by such belts and other means for the cutting reel being rotated (such as a roller or V-belt drive or chain) can be implemented. The cutting reel is typically a multi-blade configuration (e.g., eight blades) with each blade typically having 90 degrees of rotation from one end of the cutting reel to the other end. This is often referred to as a “lawn mower” style cutting reel. However, a single blade and/or a different degree of rotation of the blade(s) from end to end can be employed. The cutting reel is typically made from a steel alloy, but other metals can be used, provided that they provide sufficient stiffness to keep the cutting interface narrow across the entire cutting tangent and hard enough to keep a sharp edge for a reasonable period of cutting time. For example, certain stainless steels, aluminum alloys, or even titanium could be employed. However, these metals are generally more expensive and/or more difficult to machine, and therefore, are not preferred.

Compared to the existing single horizontal fixed or rotating blade or a dual converging belt designs, the cutting reel embodiment provides a much more robust cutting interface that produces less waste and a higher quality of finish trimming to the flower, bud or other portion of the plant desired as an end product. It also creates a much safer apparatus because the cutting interface is near the bottom of the slotted drum, and inside a protective cover, so it is less likely that a human operator can be injured unless a hand is intentionally inserted into the slotted drum and the fingers pressed through a slot.

Embodiments of the invention utilize a novel vacuum manifold that completely encloses the cutting reel for safety and for a better vacuum effect to remove plant waste. The manifold is made with a hinge and is held in place with spring-loaded pins so that it is easy to remove it for cleaning and for sharpening of the cutting reel.

Compared to the existing art in the field, the spring pinned, hinged vacuum manifold embodiment provides a much tighter vacuum chamber. It also enables a simpler procedure for opening and removing the slotted drum and the cutting reel, in particular, for such purposes as cleaning and sharpening of the cutting and other surfaces.

Embodiments of the invention employ a metal frame that holds the cutting interface and the cleaning system in a horizontal position. Alternately, the metal frame is made so that there is the ability to operate the apparatus not only in a level position but also on a downward slope to utilize gravity to assist to the flow of the plant material through the slotted drum so that the operator will have minimal effort in keeping the flow of plant material going through the apparatus.

Compared to the existing art in the field, the metal frame that can be operated horizontally or lowered on one end, allows the use of gravity to assist the flow of plant material through the slotted drum while being processed and provides an improved means for enabling the flow and processing of plant material through the apparatus.

Embodiments of the invention employ an adjustable bearing mount mechanism for the cutting reel that permits more precise adjustment of the cutting interface to enhance the shearing force on the plant material, thereby resulting in the plant material being cleanly shorn rather than torn or crushed, with the consequence that the amount of wasted chaff is reduced, and the buildup of debris on the cutting edges is minimized, while making it is easier to clean the apparatus.

Compared to the existing art in the field, the front and rear adjustable bearing mounts for the cutting reel enable the cutting interface between the cutting reel and the slotted drum to be tailored or optimized for handling different plant materials.

The object of embodiments of the invention is to provide an apparatus and method to process plant material, in particular to the trimming of plant buds and flowers. Further details of embodiments of the invention will be described in the following portions of the specification, wherein the description is for the purpose of fully disclosing preferred embodiments of the invention without placing any limitations thereon, and are for illustrative purposes only.

### BRIEF DESCRIPTION ON THE DRAWINGS

FIG. 1 is an isometric, perspective view with exploded representation showing an embodiment of the overall apparatus and its main parts.

FIG. 1A is an isometric, perspective view showing an embodiment of the overall apparatus and its main parts from the side opposite to that shown in FIG. 1.

FIG. 1B is a view of the front of the overall apparatus shown without the cover for the timing belt and pulleys that drive the slotted drum.

FIG. 1C is a view of the rear of the overall apparatus shown without the cover for the timing belt and pulleys that drive the cutting reel.

FIG. 2 is a side view representation showing an embodiment of the overall apparatus, including the direction of flow of the plant material through the apparatus.

FIG. 2A is an exploded view of one of the sprayers on the spraying system.

FIG. 3 is an isometric, perspective view of the slotted drum embodiment showing two exemplary configurations of the slotting, the bearing surfaces on each end of the slotted drum, and the thickness of the drum.

FIG. 3A and FIG. 3B are two exemplary configurations of the possible slotting in the slotted drum, with FIG. 3A showing the slotting being in-line and FIG. 3B showing the slotting being offset.

FIG. 3C is a detailed, side view of the bearing surfaces on the slotted drum.

FIG. 4 is an isometric, perspective view of the cutting reel embodiment showing the multiple blades (eight) and 90 degrees of blade rotation from end to end of the cutting reel.

FIGS. 5A, 5B, and 5C are three direct facing perspective views of the interface of the slotted drum with the cutting reel showing a representative view of the movement of selected cutting blades across the slotted drum illustrating how the shear point moves along a tangent line which extends between the cutting reel blades and the slotted drum.

FIG. 6 is an end view of the apparatus showing the cleaning fluid sprayer system and the roller cleaning brush embodiments at the top, the slotted drum below them, the cutting reel below the slotted drum, the hinged vacuum manifold, a typical canister vacuum connected by a hose to the vacuum manifold, the frame and front end plate, and the path of airflow and plant trimmings (debris) through the invention.

FIG. 6A is an end view of the cutting interface embodiment showing the geometric relationship between slotted drum and cutting reel center lines.

FIG. 7A is an isometric, perspective view of the vacuum manifold embodiment showing the location of the hinge and a dotted line representation of the hinged portion of the manifold in an open position, pulled away from the cutting reel.

FIG. 7B is an isometric, perspective exploded view of the spring loaded mounting pins on the vacuum manifold used to hold it in place.

FIG. 7B is an isometric, perspective exploded view of the hinge on the vacuum manifold.

FIG. 8 is an isometric, perspective view of the metal frame embodiment with the two end plates (front and rear) that hold the bearings for the slotted drum, the circular bearing mounts for the cutting real, the electric motors for driving the slotted drum and cutting reel, the cover plates for the drive belts, and the wheels.

FIGS. 9A and 9B are close up, isometric views of the adjustable spring pin embodiment on the bottom of the back leg of the metal frame that allows height adjustment of the frame to allow for more gravity induced material flow.

FIG. 10A is an isometric, perspective view of the adjustable bearing mount embodiment that holds the end of the cutting reel showing the small offset of the hole that holds the press fitted bearing from true center.

FIG. 10B is a cutaway side view of the adjustable bearing mount embodiment taken along section line 10B-10B of FIG. 10A with the front or rear frame mounting plate sandwiched between the adjustable bearing mount and its clamping plate on the reverse side of the front or rear frame mounting plate.

FIGS. 11A, 11B, 11C and 11D are end views of the adjustable bearing mount embodiment for the cutting reel showing an adjustable bearing mount rotated 90 degrees from the previous figure to show the location of the eccentric offset of the centerline of the bearing and the corresponding variance in distance between the edge of a cutting blade and the bottom of the slotted drum.

### DETAILED DESCRIPTION

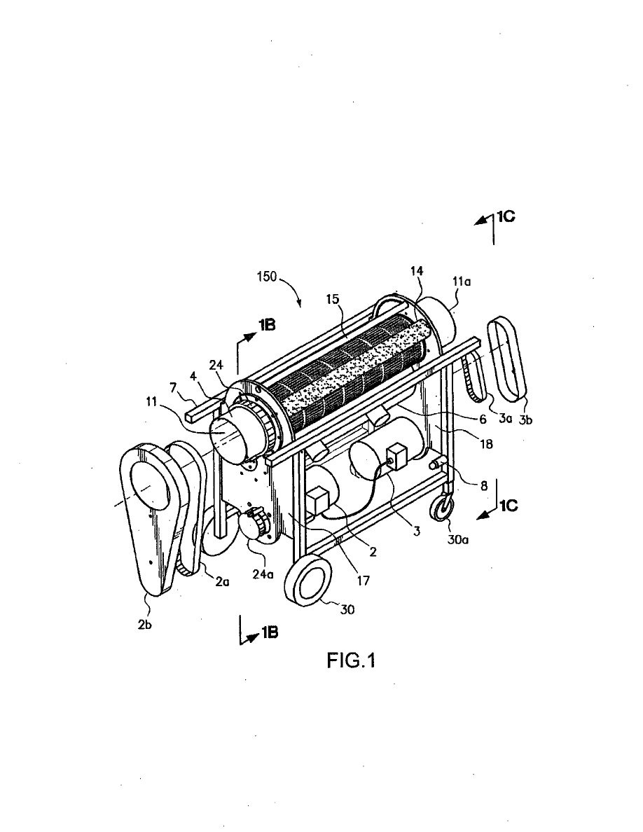

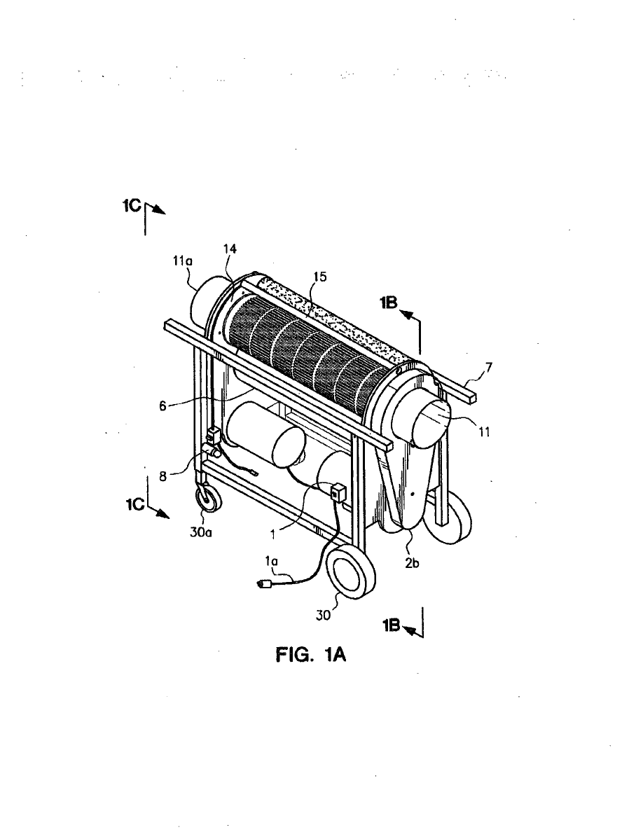

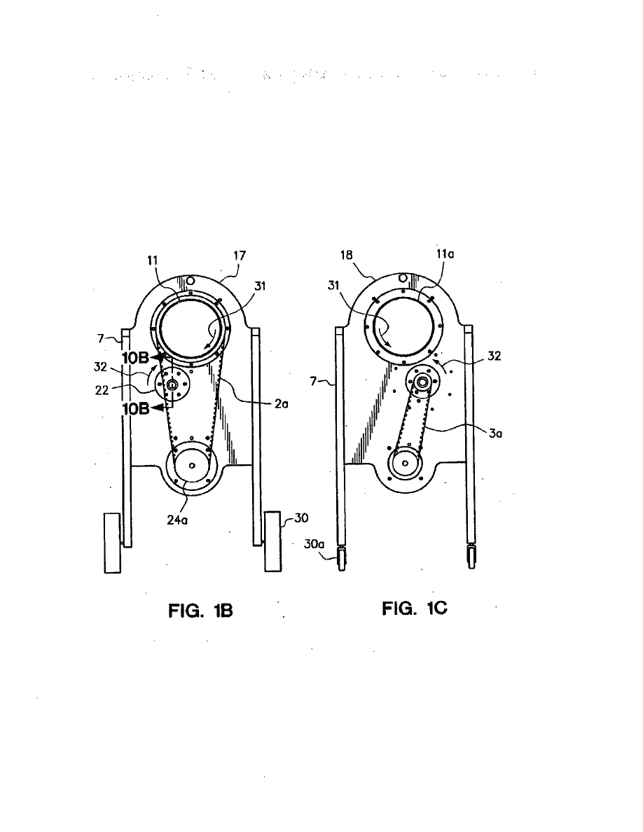

Referring more specifically to the drawings, for illustrative purposes the present invention is embodied in the apparatus generally shown in FIG. 1 through FIG. 11D.

The example of a slotted drum 4 in FIG. 3 through FIG. 3C shows a ⅛ inch thick tube 4a that has ground bearing surfaces 4b and 4c on either end and has horizontal rows 4d with seven slots 12 that are 5/16 inches wide by 4 inches long and that can be differently aligned as shown in FIG. 3A and FIG. 3B. However, one skilled in the art would appreciate that similar slotted drums with a different number of slots per horizontal row and/or with slots of different widths and lengths and/or a drum of a different thickness could be used.

The example of a cutting reel 5 in FIG. 4 shows a “lawn mower” type of cutter with eight blades 5a with 90 degrees of end to end blade rotation. The cutter may also be referred to herein as the cutting reel 5 or other similar terms, where appropriate. One skilled in the art would appreciate that similar cutting reels 5 or equivalent implements with either a different number of blades and/or different degree of end to end rotation could be used.

The example of the progressing cutting tangent line 9 shown in FIGS. 5A through 5C has a typical offset of 12 degrees from the bottom of the slotted drum 4 as shown in FIGS. 6 and 6A. However, one skilled in the art would appreciate that the degree of offset of the cutting tangent line 9 from the bottom of the slotted drum could vary depending upon a variety of factors such as, but not limited to, the number of blades in the cutting reel 5, the degree of rotation of the cutting blades from end to end, the speed of operation of the slotted drum and cutting reel, the diameter of the cutting reel 5 and/or the drum 4, and/or the type of plant material.

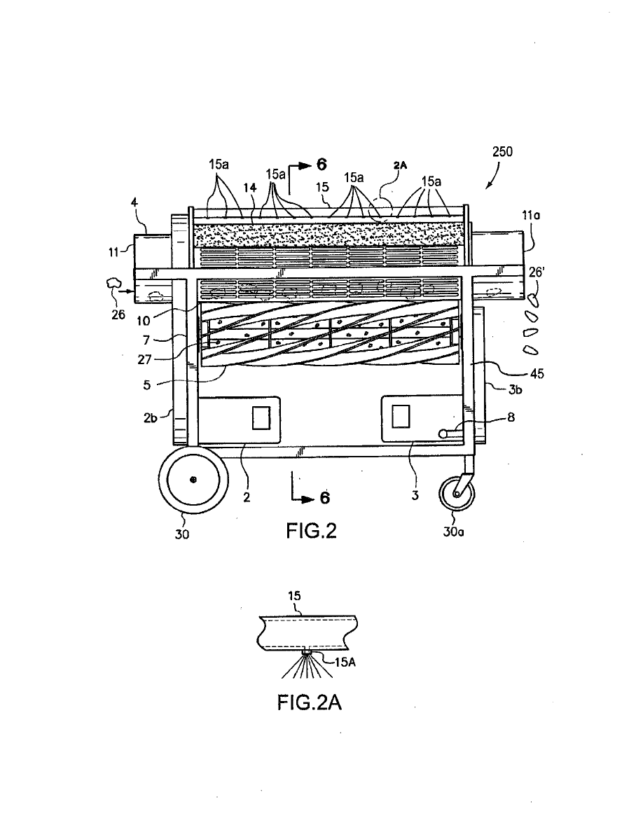

One example of a roller brush 14 and cleaning liquid sprayer system 15 with fluid shut off valve 16 and fluid input line 16a for cleaning the slotted drum 4 is given in FIG. 1, FIG. 1A, FIG. 2, FIG. 2A, and FIG. 6. However, one skilled in the art would appreciate that similar roller brushes 14 with different diameters or made from different bristles and similar liquid sprayer systems 15 with different spacing, configuration, control valve, and nozzles 15a can be used. The liquid sprayer system 15 may also be referred to herein as a liquid sprayer 15, the roller brush 14 may also be referred to herein as a roller cleaning brush 14, and the shut off valve may be referred to herein as a valve 16.

The example of a hinged manifold 6 in FIG. 7A, FIG. 7B, and FIG. 7C shows a manifold that uses spring-biased pins 19 to hold it in place and a hinge 29 that allows one side of the manifold 6 to be opened while in place. However, one skilled in the art would appreciate that the manifold can have a different shape, a different or no hinge mechanism, and/or a different means of attachment to the apparatus (e.g., screws instead of spring loaded pins).

The example of a metal frame 7 as depicted in FIG. 1, FIGS. 1A through 1C, FIG. 2, FIG. 6, FIG. 8, and FIGS. 9A and 9B shows a frame made from square metal stock with a fixed height and larger wheels on one end and smaller wheels with a height adjustment mechanism on the other end. However, one skilled in the art would appreciate that the frame 7 can be made from rectangular or tubular stock of different metals, plastics and/or carbon composition material, and further, that differently sized wheels 30 and 30a and a different height adjustment mechanism 21 for lowering the frame on one end can be used.

The example of an adjustable bearing mount 22 in FIG. 10A and FIG. 10B and FIGS. 11A through 11D shows an adjustable bearing system that allows for precision adjustment of the distance of the cutting reel blades 5a from the slotted drum 4. However, one skilled in the art will appreciate that a different bearing adjustment mechanism to control the cutting distance could be used.

It will be appreciated that the apparatus may further vary as to configuration and as to details of the parts, and that the method may vary as to details and the order of the steps, without departing from the basic concepts as disclosed herein.

One Example of a Typical Operation: Referring to FIG. 1, FIGS. 1A-1C, FIG. 2, and FIG. 6, the plant trimming system is set out pictorially. The system is used by turning on the single pole on/off power switch 1 which sends power to the 110 vac single phase motors 2 and 3 as illustrated in FIG. 1. Motor 2 causes slotted drum 4 (see FIG. 3, FIGS. 3A-3C, & FIGS. 5A-5C for detail of slotted drum 4) to turn clockwise as represented by arrow-headed curved line 31 (when viewed from the front) at a typical speed of 60-70 rpm by means of drive belt 2a (as illustrated in FIG. 1B and FIG. 6), and motor 3 causes cutting reel 5 to turn clockwise as represented by arrow-headed curved line 32 at a typical speed of 1800-2800 rpm by means of drive belt 3a as represented by and illustrated in FIG. 1C and FIG. 6. [Note: Referring to FIG. 1, indicium 2b denotes the cover for drive belt 2a and indicium 3b denotes the cover for drive belt 3a.] The differential rotation [note: there is a differential in rotation between slotted drum 4 and cutting reel 5 because they are rotating in the same direction], combined with the vacuum inside the vacuum manifold 6 (as shown in FIG. 6 and FIG. 7), the force of gravity (which is increased if the frame 7 is lowered on the rear end 45 by height adjustment mechanism 8, as also illustrated in FIGS. 9A and 9B), and the movement of the blades 5a on the cutting reel 5 across the cutting interface 10, causes plant material 26 to migrate from the entrance side 11 of slotted drum 4 towards the exit side 11a of slotted drum 4 (see FIG. 2 showing the migration of plant material 26 through slotted drum 4).

Referring to FIG. 1, FIG. 3, FIG. 4, FIGS. 5A-5C, and FIG. 6, as the plant material 26 migrates as generally depicted in FIG. 2 through slotted drum 4 from the front end (entrance) 11 to the rear end (exit) 11a, gravity and the vacuum from the vacuum manifold 6 pulls leaves, stems and other unwanted plant parts extending from a plant material body through an individual slot 12 into the cutting interface 10 as generally depicted in FIG. 6. Such unwanted plant material may be referred to herein as plant waste 27. At the cutting interface 10, which may be comprised of the point at which the cutting reel 5 contacts or nearly contacts the drum 4, the cutting reel 5 may slice off such unwanted plant parts along the cutting tangent line 9 (as shown in FIGS. 5A-5C) as a blade 5a on the cutting reel 5 comes into contact with and then shears off the plant waste 27 pressed against the edge of a slot 12 in slotted drum 4 (as shown in FIG. 6). The plant waste 27 is then received by the vacuum manifold 6 and exhausted through the exit holes 20 (see FIGS. 6 and 7A) in the vacuum manifold 6 through a flexible hose 28 to whatever type of trap or waste collector 13 is desired. Referring to FIG. 6, the dotted lines with arrows in the figure indicate the direction of airflow inside slotted drum 4 and then, after the excess plant material 26 (i.e., plant waste 27) is removed at the cutting interface 10, the dashed arrow also indicate the flow of the plant waste 27 through the vacuum manifold 6 into the hose 28 and waste collector 13.

Referring to FIGS. 1, 1B, 2, and 6, the roller cleaning brush 14 may be engaged against the slotted drum 4 to brush away plant waste. The operator may also choose to turn on the cleaning system sprayer 15 using the valve 16. Alternatively, the valve 16 may be automatically enabled and disabled through a control system 40. The control system 40 may comprise various hardware and software adapted to control the valve in order to apply an appropriate amount of cleaning fluid for given input parameters. Such parameters may be comprised of the type of plant, the amount of plant material, the type of cleaning solution, and the size and type of the different apparatus 250 features, etc. Turning on the valve 16 may cause a cleaning fluid such as, but not limited to, water, to be drawn through a fluid supply line 16a and then sprayed through one or more nozzles 15a on the cleaning system sprayer 15, onto the slotted drum 4. In one embodiment, the nozzles 15a may be positioned to spray the cleaning fluid so that the fluid is released onto the drum 4 generally at Section A of the drum 4, as seen in FIG. 6.

In the FIG. 6 embodiment, the drum 4 rotates in a counter-clockwise direction 42. In such an embodiment, newly wetted Section A would then rotate towards the roller cleaning brush 14. The roller cleaning brush 14 may also rotate in the same direction, or may rotate in a direction opposing the drum's 4 rotational direction, and would then contact the wetted portion of the slotted drum 4 after the cleaning solution was applied to the drum 4 and before the cutting reel 5 contacts the drum 4, as seen at section B in FIG. 6A. Although Section A is seen in FIGS. 6 and 6A as generally opposing Section B, it is contemplated that Section A may be substantially perpendicularly aligned with Section B, Section A may be located substantially next to Section B, or that Section A may be located at any position in relation to Section B. Furthermore, the roller cleaning brush 14 may be located after Section A and before Section B in the counterclockwise direction 42 rotation system seen in FIGS. 6 and 6A, or it may be located after Section B and before Section A in the same counterclockwise rotation 42 system of FIGS. 6 and 6A. A similar positioning may occur in a clockwise rotation system. However, the roller 14 may be located in any other position relative to the sprayer 15 and/or the reel 5. It is contemplated that the amount of fluid exiting a nozzle 15a may be controlled by the valve 16. Additional roller cleaning brushes 14 may also be used in varying locations and designs.

In one embodiment, it is contemplated that the cleaning system sprayer 15 may be coupled to a different location on the endplate 18 than is seen in FIG. 6. For example, a plurality of sprayers 15 may be located rotationally about the drum 4, as seen with sprayers 15c and 15b. Seen in FIG. 2 is a longitudinal cleaning system sprayer 15 comprising a plurality of nozzles 15a placed in a location generally opposing the location of the reel 5. It is contemplated that such a system may comprise more or less nozzles 15a Furthermore, additional longitudinal cleaning system sprayers 15 may be included in the plant trimming apparatus 250 seen in FIG. 2. Additionally, or in the alternative, cleaning system sprayers 15 having shapes different than the longitudinal shape seen in FIG. 2 and elsewhere are contemplated. For example, a circular shape sprayer 15 is contemplated which may encircle one or more of the drum 4, brush 14, and reel 5. However, any shape sprayer 15 is contemplated. Furthermore, although the longitudinal sprayer 15 seen in FIG. 1 extends from a first end plate 17 to a second end plate 18, it is contemplated that any sprayer 15 on the apparatus 150 may not extend between the two endplates 17, 18, but may extend from one or both endplates 17, 18 without coupling or integrating to the other of the sprayer 15.

It is further contemplated that one or more the nozzles 15a may be positioned to spray onto the brush 14 or any other portion apparatus 250. It may be determined that such indirect wetting of the drum 4 may be the most effective way to clean the apparatus 250 and/or produce the greatest quantity of finished plant material 26′ with the appropriate amount of plant waste 27 having been removed from the initial plant material 26 inserted to the apparatus 250.

An embodiment may further comprise a drum 4, roller 14, reel 5, and/or any other portion of the apparatus 650 that is adapted to receive the fluid input line 16a. In such an embodiment, the drum 4, roller 14, reel 5, and/or any other portion of the apparatus receiving the line may comprise a porous material adapted to secrete the cleaning fluid or may otherwise comprise nozzles 15a, bores adapted to release the cleaning fluid, or a drip system adapted to keep the apparatus wetted. Such a system, and/or another sprayer 15 system may be adapted to also and/or alternatively provide fluid to the inner section 44 and/or inner surface of the drum 4 or an inner or outer section/surface of any other portion of the apparatus. It is also contemplated that a drip system may be included instead of, or in addition to, the sprayer 15.

The sprayer 15 may comprise a plurality of nozzle 15a locations as seen in FIG. 2. In any embodiment, the sprayers 15 and nozzles 15a are designed, located, and adapted to clean and remove plant material from one or more of the apparatus 250 features and to improve one or more of the apparatus 250 functions. For example, certain plants may leave plant oil or resin material on the drum 4. Over time, this resin and oil may add up and begin to clog the slots 12 in the drum. Such clogging may prevent unwanted plant material from extruding through the slots 12 and therefore portions of the unwanted plant material may not be removed from the desired plant material by the reel 5. Through the use of the cleaning system 15 and brush 14 in one embodiment, the resin, oil, or other undesired plant material may be removed from the apparatus 250 so that a greater portion of the finished plant material 26′ comprises a greater amount of removed undesired plant material.

It is contemplated that the nozzle 15a seen in FIG. 2a may comprise a different nozzle type. For example, a “mister” nozzle 15a may be used, a wetted sponge may be applied to one or more of the apparatus 250 features, or a drip system nozzle 15a may be employed. Any type of nozzle 15a and sprayer 15 known in the art which is adapted to apply a fluid to an area of a device may be used.

One embodiment of the invention comprises a method of trimming plants. In such an embodiment, initial plant material 26 may be placed in the apparatus 250 as seen in FIG. 2. Through the use of gravity and/or the vacuum manifold 6, the plant material may travel from the entrance side 11 to the exit side 11a of the apparatus 250. When traveling across an inner surface of the drum 4, unwanted plant material may protrude through slots 12 in the drum 4. This unwanted plant material may be sheared away from the desired plant material though use of the reel 5. The plant waste is deposited in a receptacle 13 separate from the finished plant material 26′

Referring to FIGS. 1, 6, 7A-7C, and 8, the vacuum manifold 6 is installed for most operations. The vacuum manifold 6 is attached to the two end plates 17 and 18 by means of the spring-loaded pins 19 (see FIGS. 6, 7A and 7B). The vacuum manifold has one or more exit holes 20 (as best shown in FIGS. 6 and 7A) to which the operator may attach a hose 28 (see FIG. 6) to carry away the plant waste 27. The vacuum manifold 6 is cleaned by removing it from the apparatus. This also enables the cutting reel 5 to be cleaned and/or sharpened (and removed if and as needed).

Referring to FIG. 2 and FIGS. 9A and 9B, the frame 7 can be adjusted from a horizontal level to several inches lower on the exit side by using the height adjustment mechanism 8 which is operated by pulling on adjustment pin mechanism 21 which is comprised of a spring 21a and a pin 21b.

Referring to FIGS. 10A-10B, and FIGS. 11A-11D, the distance between the cutting reel 5 and the slotted drum 4, i.e., the cutting interface 10, can be adjusted by rotating the adjustable bearing mount 22 in relation to clamp plate 23 on the front and rear of the apparatus. By rotating bearing mount 22 in relation to clamp plate 23, the centerline 34 of the cutting reel 5 is moved around the center 33 of the clamp 23 (see FIGS. 11A through 11D). This operation is done on bearing mount 22 on each end of the apparatus. Typically, the cutting interface 10 between the cutting reel 5 blade edges and the slotted drum 4 is set for about 0.003 inches, with a typical range of 0.002 to 0.006 inches. However, the cutting interface 10 may be adjusted to optimize operation with differing plant material 26.

Other aspects and embodiments of the plant trimming apparatus comprise any one or more feature(s) disclosed herein in combination with any one or more other feature(s) or a variant or equivalent thereof. In any of the embodiments described herein, any one or more features may be omitted altogether or replaced or substituted by another feature disclosed herein or a variant or equivalent thereof.

Numerous modifications and changes to the embodiments described above will be apparent to those skilled in the art.

1. A plant trimmer for trimming materials from plants comprising:
a frame having spaced mounts;
a rotatable slotted drum supported by said mounts;
a rotatable cutting implement interfacing said slotted drum and supported by said mounts;
a motor supported by one of said frame and said mounts and coupled to said slotted drum enabling rotation thereof;
a motor mounted on the other of said frame and mounts and coupled to said cutting implement enabling rotation thereof;
and
an on-off electrical switch electrically coupled to both said motors that simultaneously turns both said motors on and off thus enabling the materials to be trimmed from the plants.

2. The plant trimmer as claimed in claim 1, wherein said cutting implement comprises a cutting reel, and further including:
adjustable bearing mounts supporting said cutting reel;
said adjustable bearing mounts held in place on said front and said rear mounting plates of said frame with a clamp that allows said adjustable bearing mounts to be adjusted and then locked in place, thereby enabling the position of said cutting reel to be raised and lowered in relation to said slotted drum.

3. The plant trimmer as claimed in claim 2 further comprising a bearing adjustment mechanism comprising:
a bearing mounting plate, said bearing mounting plate made with a small offset from center for the placement of the bearing for holding the cutting reel; said bearing mounting plate being held in place by means of a rotatable clamp on the opposite side of said front or rear mounting plates of said frame; said bearing mount being able to be un-clamped, rotated, and then re-clamped for the purpose of causing the slightly offset bearing to be closer to, or further from, the centerline of said slotted drum, thereby allowing for the adjustment of the distance (i.e., cutting interface) between said slotted drum and said cutting reel.

4. The plant trimmer as claimed in claim 1, wherein said cutting implement comprises a cutting reel, and further including a roller brush located parallel to, and in contact with, said slotted drum and held in place between said front and rear mounting plates of said frame by bearings.

5. The plant trimmer as claimed in claim 4 wherein said roller brush is held in place by bearings that can be adjusted in location so that the distance and pressure between said roller brush and said slotted drum can be adjusted for optimal cleaning of said slotted drum.

6. The plant trimmer as claimed in claim 1, wherein said cutting implement comprises a cutting reel, and further including a liquid sprayer located parallel to said slotted drum between said front and rear mounting plates of said frame.

7. The plant trimmer as claimed in claim 6 wherein said liquid sprayer includes a valve which is actionable to adjust the flow of liquid from off to full pressure for optimal cleaning of said slotted drum.

8. The plant trimmer as claimed in claim 1, wherein said frame includes front and rear ends and a height adjustment mechanism on one of said ends to allow said frame to slant downwards on the other of said ends.

9. The plant trimmer as claimed in claim 1, wherein said frame includes front and rear ends and pairs of wheels respectively on said front and rear ends to allow said plant trimmer to be rolled from location to location.

10. A plant trimmer for trimming materials from plants including:
a frame having front and rear mounting plates comprising spaced mounts;
a rotatable cylindrical drum defining a cylindrical surface held between said front and rear mounting plates by bearings supported by said mounts, said drum having spaced slots in said surface;
a rotatable cutting reel having cutting blades located parallel to and below said slotted drum and between said front and rear mounting plates mounts;
an adjustable mechanism coupled to said cutting reel enabling said blades thereof to be set at adjustable distances from said slotted drum surface and said spaced slots thereof, said mechanism being adjustable in conformity to the type of plant material;
a motor mounted on said front mounting plate and supported thereby and coupled to said slotted drum by a belt enabling rotation thereof in a first direction;
a motor mounted on said rear mounting plate and coupled to said cutting reel by a belt enabling rotation thereof in the same direction as said slotted drum;
a hinged manifold enclosing said cutting reel enabling access thereto for removal thereof and cleaning and sharpening of said blades;
an on-off electrical switch electrically connected to both said motors and disposed to simultaneously turn both said motors on and off thus enabling the materials to be trimmed from the plants;
a roller brush located parallel to, and in contact with said slotted drum, adjustably positioned with respect to said drum surface and held in place therewith between said front and rear mounting plates, said roller brush enabling cleaning said slotted drum of the plant material, the adjustability of the positioning being such as to adjust the distance and pressure between said roller brush and said slotted drum for optimal cleaning of said slotted drum; and
a liquid sprayer coupled to a source of cleansing liquid and located parallel to said slotted drum between said front and rear mounting plates of said frame, said liquid sprayer including a valve which is actionable to adjust the flow of the liquid from off to full pressure for optimal cleaning of said slotted drum.

11. The plant trimmer as claimed in claim 1, further including:
adjustable bearing mounts supporting said cutting reel;
said adjustable bearing mounts held in place on said front and said rear mounting plates with a clamp that allows said adjustable bearing mounts to be adjusted and then locked in place, thereby enabling the position of said cutting reel to be raised and lowered in relation to said slotted drum, thus enabling the adjustment of the distance (i.e., cutting interface) between said slotted drum and said cutting reel.

12. A method for trimming materials from a plant comprising the steps of:
rotating a slotted drum with respect to a cutting implement interfacing the slotted drum; and
inserting the plant within the slotted drum thus enabling the materials to be trimmed from the plant.

13. The method according to claim 12 further comprising the step of adjusting the interface between said slotted drum and said cutting implement by un-clamping, rotating, and then re-clamping bearing mounting plates holding said cutting implement, said bearing mount plates having a small offset from center for the placement of the bearing for holding said cutting implement, thereby allowing for the adjustment of the distance (i.e., cutting interface) between said slotted drum and said cutting implement.

14. The method according to claim 12 further comprising the step of cleaning said slotted drum with a roller brush located parallel to, and in contact with said slotted drum.

15. The method according to claim 12 further comprising the step of cleaning said slotted drum with a liquid sprayer coupled to a source of cleansing liquid and located parallel to said slotted drum.

16. The method according to claim 12 further comprising the step of adjusting the slant of said slotted drum from horizontal to lower on one end of said slotted drum by using a height adjustment mechanism on one end of the frame holding said slotted drum.
